(19) United States
(12) Patent Application Publication
(10) Pub. No.: US 2021/0382295 A1
(43) Pub. Date: Dec. 9, 2021

(54) MAGNIFYING CAP FOR PRESCRIPTION BOTTLE

(71) Applicant: Raynard Booker, Atlanta, GA (US)

(72) Inventor: Raynard Booker, Atlanta, GA (US)

(21) Appl. No.: 17/303,628

(22) Filed: Jun. 3, 2021

Related U.S. Application Data
(60) Provisional application No. 63/033,991, filed on Jun. 3, 2020.

(51) Int. Cl. G02B 25/00; G02B 25/02; H01M 50/247; F21L 4/02; B65D 50/04

(52) U.S. Cl. CPC G02B 25/007; G02B 25/02; F21W 2131/20; F21L 4/02; B65D 50/041; H01M 50/247

(57) ABSTRACT

A magnifying cap for a prescription bottle is disclosed. The cap has a magnifying lens retained within the cap between a top aperture and an opening at the bottom end. The magnifying lens is oriented to provide a magnification of indicia carried on an outer surface of the prescription bottle, when viewed through the aperture and the opening. An illumination source may be provided around a periphery of the magnifying lens to illuminate the indicia for better viewing.

### CROSS-REFERENCE TO RELATED APPLICATION

This application claims the benefit of priority of U.S. provisional application No. 63/033,991 filed Jun. 3, 2020, the contents of which are herein incorporated by reference.

### BACKGROUND OF THE INVENTION

The present invention relates to bottles and lidded containers, and more particularly to prescription bottles.

Prescription bottles and containers are utilized to dispense medications in either pill, tablet, capsule, vials, ointments, and the like. While the prescription is carried within the bottle, the outer surface of the container often carries a number of markings, from the patient's name, the medication name, dose of the medication. The outer surface of the container may also include stickers and such for special instructions for taking or applying the medication. Due to the quantity of information that is attempted to be presented on the bottle, the type is often very small, and can be difficult to read, particularly for elderly patients and patients with impaired vision.

The patient, or caregiver may often need a magnifier and an illumination source to be able to adequately read all the information carried on the prescription bottle. These may not always be readily available and can lead to the patient or caregiver missing important instructions for administering the medication.

As can be seen, there is a need for improved prescription bottle that provides for improved readability of the markings and instructions on a prescription bottle.

### SUMMARY OF THE INVENTION

In one aspect of the present invention, a magnifying cap for a prescription bottle is disclosed. The magnifying cap includes a cap having a coupling configured to join with a cooperating coupling of the prescription bottle. The cap has an aperture at a top surface thereof and an opening to an interior of the prescription bottle at a bottom end thereof. A magnifying lens is retained within the cap between the aperture and the bottom end. The magnifying lens is oriented to provide a magnification of indicia carried on an outer surface of the prescription bottle, when viewed through the aperture and the opening. An illumination source is carried around a periphery of the magnifying lens. A battery compartment is included to contain a battery for powering the illumination source. The cap also has a switch to selectively activate the illumination source.

In some embodiments, a lens carrier is contained within the cap. The lens carrier is configured to position the magnifying lens at a desired focal length within the cap. The illumination source may include one or more bulbs. The one or more bulbs are light emitting diodes (LEDs).

In some embodiments, an illumination ring is carried within the cap. The illumination ring contains the illumination source. The cap may also include a channel defined in the illumination ring. The illumination source is carried within the channel.

In other aspects of the invention, a magnifying cap for a bottle includes a cap having a coupling configured to join with a cooperating coupling of the bottle. The cap has an aperture at a top surface thereof and an opening to an interior of the bottle at a bottom end thereof. A magnifying lens is retained within the cap between the aperture and the bottom end. The magnifying lens is oriented to provide a magnification of indicia carried on an outer surface of the prescription bottle, when viewed through the aperture and the opening.

In some embodiments, the magnifying cap includes an illumination source carried around a periphery of the magnifying lens.

In some embodiments, a battery compartment is provided to contain a battery for powering the illumination source. A switch is provided to selectively activate the illumination source.

In some embodiments, a lens carrier is contained within the cap. The lens carrier is configured to position the magnifying lens at a desired focal length within the cap.

In other embodiments, the illumination source includes one or more bulbs. The one or more bulbs may be light emitting diodes (LEDs).

In other embodiments, an illumination ring is carried within the cap. The illumination ring contains the illumination source. A channel may be defined in the illumination ring and the illumination source carried within the channel.

In yet other embodiments, the magnifying cap includes a child resistant lock.

These and other features, aspects and advantages of the present invention will become better understood with reference to the following drawings, description and claims.

### BRIEF DESCRIPTION OF THE DRAWINGS

FIG. 1 is a perspective view of the magnifying cap for prescription bottle, shown in use applied to a bottle;

FIG. 2 is a top perspective view of the magnifying cap for prescription bottle;

FIG. 3 is a bottom perspective view of the magnifying cap for prescription bottle;

FIG. 4 is a front perspective exploded view of the magnifying cap for prescription bottle;

FIG. 5 is a rear perspective detail exploded view of the magnifying cap for prescription bottle;

FIG. 6 is a section view of the magnifying cap for prescription bottle taken along line 6-6 in FIG. 2;

FIG. 7 is a section view of the magnifying cap for prescription bottle, showing the depression of switch 30 to connect battery 20 to lights 38; and

FIG. 8 is a perspective view of the magnifying cap for prescription bottle, shown in an alternate arrangement for use as a flashlight.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide a cap for a prescription bottle that has an integral magnifying glass to facilitate reading instruction labels on a prescription bottle. The cap may also include an illumination source to facilitate illumination of the instructions to be read with the magnifier.

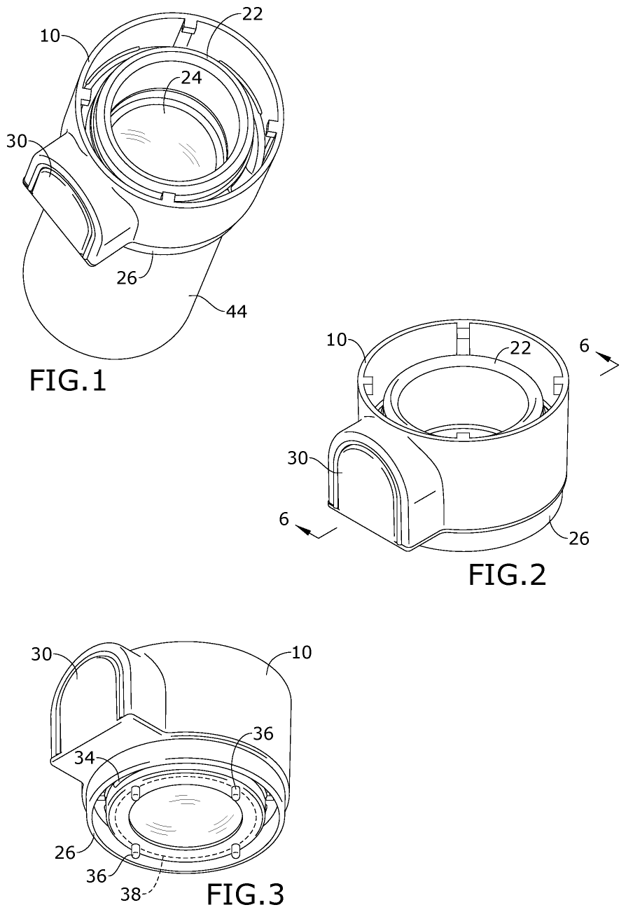

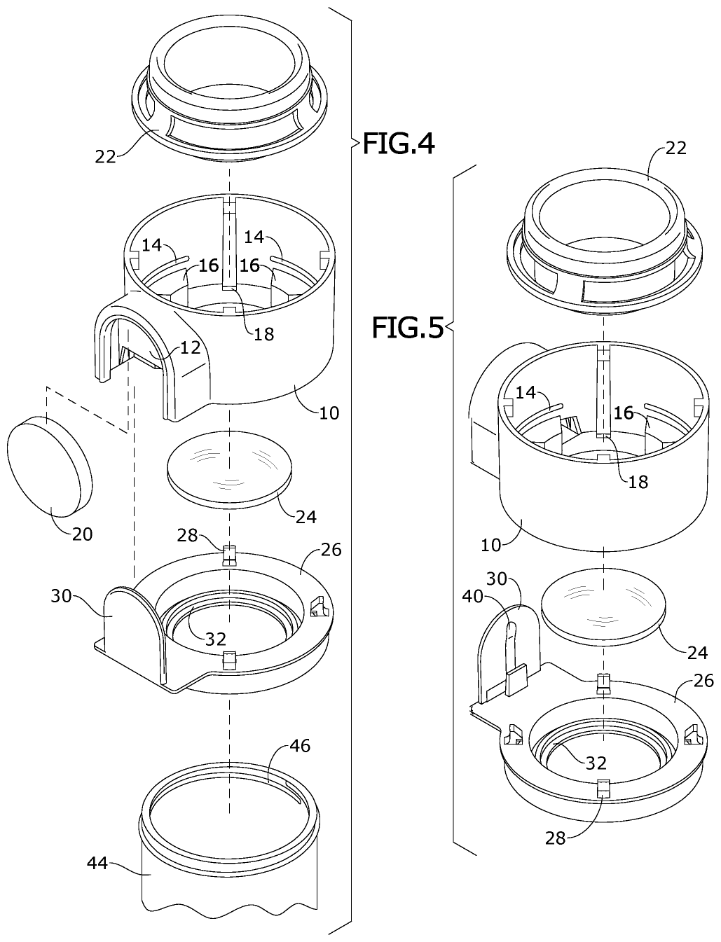

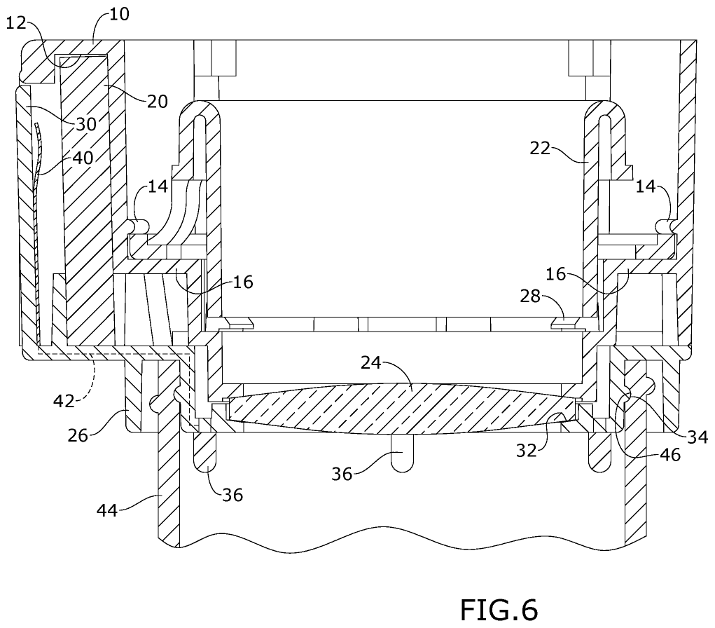

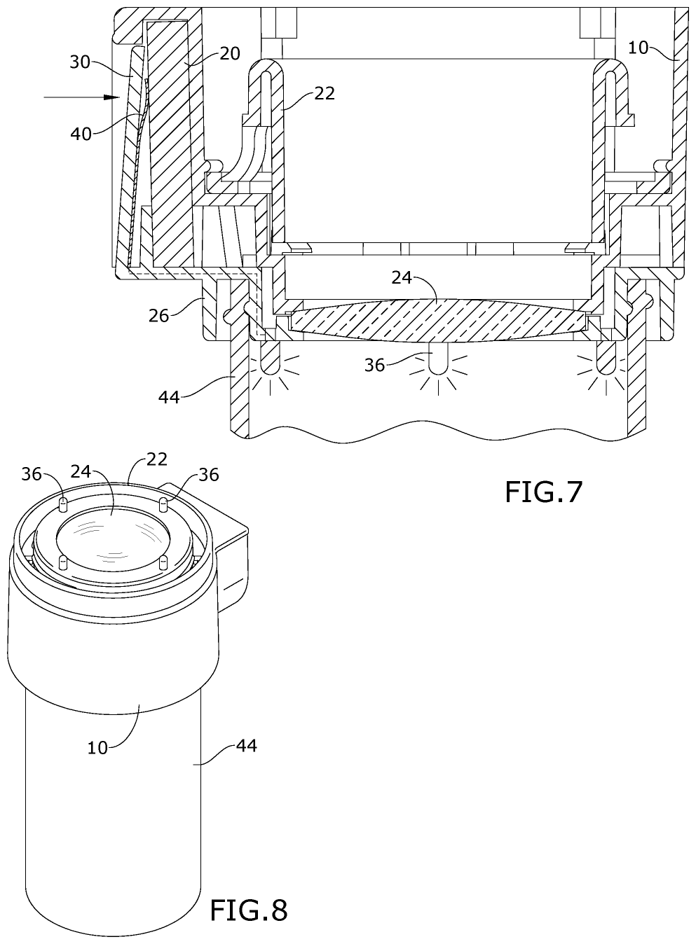

As seen in reference to the drawings of FIGS. 1-8, a non-limiting embodiment of a prescription bottle cap according to aspects of the present invention is illustrated. The bottle cap includes an outer cap 10, an illumination ring 26, and an inner cap 22. The illumination ring 26 includes a coupling for engagement of the cap with a cooperating coupling of the prescription bottle 44. Depending on the configuration of the prescription bottle 44 and the cap, the coupling and cooperating coupling may be a threaded engagement, a snap fit coupling, and the like. In the embodiment shown, the threads 34 in the illumination ring 26 may be coupled with cooperating threads 46 around a top opening of the prescription bottle 44 or around a periphery of the top opening of the prescription bottle 44. The threads 34 and cooperating threads 46 may be arranged in an internal or an external arrangement. The coupling and cooperating coupling may also include a child safety lock mechanism.

A lens shelf 32 is provided surrounding an aperture on an interior surface of the illumination ring 26. The lens shelf 32 supports the magnifying lens 24 within the cap. One or more protrusions 28 are provided to interconnect the illumination ring 26 with a slot 18 defined in an interior surface of the outer cap 10. The magnifying lens 24 is positioned on the lens shelf 32 and is aligned with the top surface of the cap to allow the user to look through the cap carrying the magnifying lens 24 and read the instructions that are carried on the prescription bottle 44. The magnifying lens 24 may be retained within the outer cap 10 by a generally cylindrical lens retainer 15, such as an annular rim of the outer cap 10 that urges the magnifying lens 24 into mating abutment with the lens shelf 32 when the outer cap 10 is joined with the illumination ring.

One or more bulbs 36 may be embedded or carried by the illumination ring 26 of the prescription bottle cap. The one or more bulbs 36, may for example, be light emitting diodes (LEDs). A battery compartment 12 may be provided within the outer cap 10 to power the one or more bulbs 36. Likewise, a switch 30 may be provided to selectively activate illumination of the bulbs 36, when desired. The one or more bulbs 36 are disposed around a periphery of the magnifying lens 24. The one or more bulbs 36 are shielded and/or focused to illuminate away from the magnifying lens 24 so as to illuminate the instructions on the prescription bottle 44. In the non-limiting embodiment shown, the one or more bulbs 36 may be carried within a circumferential surface of the illumination ring 26.

In the non-limiting embodiment shown, the illumination ring 26 may also include a distending tab 30 that covers an access to the compartment 12. The distending tab 30 may have a contact 40 on an interior face thereof for selectively contacting a battery 20 contained within the battery compartment 12. Electrical leads 42 may be carried on embedded with the illumination ring 26 for conduction between the contact 40, the battery 20 and the one or more bulbs 36. The distending tab 30 may also provide an access cover for the battery compartment 12 for replacement or servicing of the battery 20, when needed.

A top end of the outer cap 10 may also be configured for reversible coupling of the cap to a prescription bottle 44. An inner cap 22 is configured for a snap fit coupling with an annular rim 14 projecting inwardly from an inner surface of the outer cap 10. The inner cap 22 is also supported on an annular shelf 16 of the outer cap 10. With this configuration, the cap may be reversibly coupled to the bottle 44. When equipped with lights 36, the magnifying cap and the bottle 44 may be utilized as an emergency flashlight.

It should be understood, of course, that the foregoing relates to exemplary embodiments of the invention and that modifications may be made without departing from the spirit and scope of the invention as set forth in the following claims.

What is claimed is:

1. A magnifying cap for a prescription bottle, comprising:
a cap having a coupling configured to join with a cooperating coupling of the prescription bottle, the cap having an aperture at a top surface thereof, and an opening to an interior of the prescription bottle at a bottom end thereof;
a magnifying lens retained within the cap between the aperture and the bottom end, the magnifying lens oriented to provide a magnification of indicia carried on an outer surface of the prescription bottle, when viewed through the aperture and the opening; and
an illumination source carried around a periphery of the magnifying lens;
a battery compartment to contain a battery for powering the illumination source; and
a switch to selectively activate the illumination source.

2. The magnifying cap of claim 1, further comprising:
an illumination ring contained within the cap, the illumination ring configured to retain the magnifying lens at a desired focal length within the cap.

3. The magnifying cap of claim 2, the illumination source further comprising:
one or more bulbs.

4. The magnifying cap of claim 3, wherein the one or more bulbs are light emitting diodes (LEDs).

5. The magnifying cap of claim 3, further comprising:
the illumination ring containing the illumination source.

6. The magnifying cap of claim 5, further comprising:
a channel defined in the illumination ring; and
the illumination source carried on a periphery of the channel.

7. A magnifying cap for a bottle, comprising:
a cap having a coupling configured to join with a cooperating coupling of the bottle, the cap having an aperture at a top surface thereof, and an opening to an interior of the bottle at a bottom end thereof; and
a magnifying lens retained within the cap between the aperture and the bottom end, the magnifying lens oriented to provide a magnification of indicia carried on an outer surface of the bottle, when viewed through the aperture and the opening.

8. The magnifying cap of claim 7, further comprising:
an illumination source carried around a periphery of the magnifying lens;
a battery compartment to contain a battery for powering the illumination source; and
a switch to selectively activate the illumination source.

9. The magnifying cap of claim 8, further comprising:
a lens carrier contained within the cap, the lens carrier configured to position the magnifying lens at a desired focal length within the cap.

10. The magnifying cap of claim 9, the illumination source further comprising:
one or more bulbs.

11. The magnifying cap of claim 10, wherein the one or more bulbs are light emitting diodes (LEDs).

12. The magnifying cap of claim 11, further comprising:
the illumination ring containing the illumination source.

13. The magnifying cap of claim 12, further comprising:
a channel defined in the illumination ring, the channel configured for cooperative engagement with the bottle; and
the illumination source carried around a periphery of the channel.

14. The magnifying cap of claim 13, further comprising:
a child resistant lock.
